(19) United States
(12) Patent Application Publication
(10) Pub. No.: US 2011/0117374 A1
(43) Pub. Date: May 19, 2011

(54) PAPER COATED WITH SILICON, VESSEL USING THE SAME AND MANUFACTURING METHOD THEREOF

(76) Inventor: Kyung Sung Cho, Seoul (KR)

(21) Appl. No.: 12/743,256

(22) PCT Filed: Nov. 13, 2008
(86) PCT No.: PCT/KR08/06678

§ 371 Date: May 17, 2010

(30) Foreign Application Priority Data
Nov. 19, 2007 (KR) 10-2007-0117983
Oct. 29, 2008 (KR) 10-2008-0106627

(51) Int. Cl. B05D 3/02; B32B 29/00

(52) U.S. Cl. 428/452; 427/397.7

(57) ABSTRACT

Disclosed herein is a method of manufacturing a silicon-coated paper vessel, including the steps of: (a) providing liquid silicon and toluene; (b) mixing the liquid silicon and the toluene at a predetermined weight ratio to prepare a mixed solution; (c) applying the mixed solution on paper and then heating and curing the applied mixed solution to form paper coated with the mixed solution; and (d) forming the paper coated with the mixed solution into a paper vessel. The silicon-coated paper vessel manufactured using the method is advantageous in that the silicon-coated paper vessel is not harmful to the human body and exhibits high food storage capacity and high chemical stability. Further, the method is advantageous in that the silicon-coated paper vessel can be easily manufactured by pressing the silicon-coated paper using a die assembly or by adhering the silicon-coated paper to non silicon-coated paper.

### TECHNICAL FIELD

The present invention relates to a paper vessel which is not harmful to the human body, and, more particularly, to silicon-coated paper which is not harmful to the human body because it is coated with silicon and which can safely store food, a paper vessel using the silicon-coated paper, and a method of manufacturing the paper vessel.

### BACKGROUND ART

In present-day life, since men have many spheres of activity, are busy for a long period of time and acquire a lot of information, they must efficiently use a limited amount of time.

Among men's activities, it is necessarily required to eat food in order to obtain energy. Even in men's busy social life, it is required to rapidly and conveniently eat food within a limited period of time.

Further, in present-day life, as disposable products are increasingly used because of the advancement of science and technology, improvements in quality of life and culture, the pursuit of conveniences and the like, various disposable vessels, such as cups for vending machines, vessels for beverages, vessels for Cup Ramen, vessels for take out orders, vessels for ice cream and the like, are being developed and used.

Such disposable vessels are often made of paper, and the disposable vessels made of paper are coated therein with a waterproofing material in order to solve the problem of hygroscopicity.

Conventionally, polyethylene (PE) is frequently used to coat the disposable vessels made of paper.

Generally, polyethylene (PE) is known as a plastic, and is a chemical material used to produce goods helpful for living because it does not rust and rot and has excellent chemical stability, water resistance, flexibility, insulation properties, formability and the like.

Polyethylene (PE) is used to coat various food vessels for the purpose of water-proofing or is used as a material for wrapping because it is very hygienic towards food and is relatively cheap, but is disadvantageous in that it has low heat resistance.

For example, disposable vessels, such as paper cups and the like, are generally coated on the inside with polyethylene.

However, these disposable vessels coated with polyethylene are problematic in that they cannot be reused due to the aggregation of polyethylene during a recycling process, that air pollution is caused by the generation of soot and smoke when they are incinerated, and that soil pollution is caused because it takes several hundred years to naturally decompose them even when they are buried.

Further, since polyethylene generates environmental hormones depending on the conditions of its use and causes users to be exposed to carcinogenic substances, when the human body is exposed to the carcinogenic substances for a long period of time, toxicity results. Therefore, the polyethylene has many problems related to food hygiene and safety.

In particular, it is presumed that polyethylene (PE) generates PFOA (Perfluoro Octanic Acid), which is an environmental hormone, when it comes into contact with a hot body of about 100° C. Therefore, it is required to develop a substitute for it.

In order to solve the above conventional problems, Korean Patent Registration No. 660980 (2006. 12. 18) discloses “Environmentally friendly and recyclable Water Soluble Resin for food-wrapping and Paper vessel using the same”. It is described in this patent document that paper is coated with a mixture in which a slipping agent and dispersing agent are mixed with one or more water soluble resins in order to overcome the problem in which, when the thickness of the paper used in the vessel is less than 300 μm, pulp cannot be regenerated or recycled due to the polyethylene applied on the paper, and only when the thickness thereof is more than 350 μm, it can be recycled but the yield does not exceed 80%.

However, in the above conventional technology, an environmentally friendly aspect in which pulp can be recycled is somewhat improved because acrylic emulsion, polyvinylidene chloride or the like is used to coat paper, silicon emulsion is used as a slipping agent and sodium dioctyl sulfosuccinate is used as a dispersing agent, but the problem in which environmental hormones are generated and users are exposed to carcinogenic substances has not yet been completely solved.

Therefore, it is required to develop a technology of manufacturing a paper vessel which is not harmful to the human body and simultaneously maintains the freshness and safety of food.

### DISCLOSURE OF INVENTION

### Technical Problem

Accordingly, the present invention has been made keeping in mind the above conventional problems, and an object of the present invention is to provide silicon-coated paper which is not harmful to the human body because it is coated with silicon.

Another object of the present invention is to provide a paper vessel manufactured using the silicon-coated paper.

A further object of the present invention is to provide a method of manufacturing the paper vessel using the silicon-coated paper.

### Technical Solution

In order to accomplish the above objects, an aspect of the present invention provides a silicon-coated paper, manufactured by applying a mixed solution on a selected area of paper in which the mixed solution is composed of liquid silicon and toluene mixed at a predetermined mixing ratio, and then heating the paper coated with the mixed solution at a predetermined temperature for a predetermined time to completely remove the toluene and simultaneously cure the liquid silicon.

In the silicon-coated paper, the mixed solution may be prepared by mixing the liquid silicon and the toluene at a weight ratio of 1:1→1:3. Further, the predetermined temperature may be in a range of 100 to 250° C., and the predetermined time may be 1 hour at 100° C. and 30 seconds ˜1 minute at 250° C. under the condition that the paper is coated with the mixed solution in which liquid silicon and toluene are mixed at a weight ratio of 1:1.

In order to accomplish the above objects, another aspect of the present invention provides a silicon-coated paper vessel on which a silicon coating layer is provided, manufactured by forming paper into a paper vessel, applying a mixed solution on the paper vessel in which the mixed solution is composed of liquid silicon and toluene mixed at a predetermined mixing ratio, and then heating the paper vessel coated with the mixed solution at a predetermined temperature for a predetermined time to completely remove the toluene and simultaneously cure the liquid silicon.

In the silicon-coated paper vessel, the silicon coating layer may be provided by forming paper into a paper vessel, applying a mixed solution in which liquid silicon and toluene are mixed at a predetermined mixing ratio on the paper vessel, and then heating the paper vessel coated with the mixed solution at a predetermined temperature for a predetermined time to completely remove the toluene and simultaneously cure the liquid silicon.

In the silicon-coated paper vessel, the mixed solution may be prepared by mixing the liquid silicon and the toluene at a weight ratio of any one selected from among 1:1, 1:2 and 1:3.

In order to accomplish the above objects, a further aspect of the present invention provides a method of manufacturing a silicon-coated paper vessel, including the steps of: (a) providing liquid silicon and toluene; (b) mixing the liquid silicon and the toluene at a predetermined weight ratio to prepare a mixed solution; (c) applying the mixed solution on paper and then heating and curing the applied mixed solution to form paper coated with the mixed solution; and (d) forming the paper coated with the mixed solution into a paper vessel.

In the method, in the step (a) of providing liquid silicon and toluene, ELASTOSIL (LR3071: Brand name), manufactured by Wacker Chemie Corp. in Germany, may be used as the liquid silicon. In the present invention, any one selected from among ELASTOSIL (LR3071) having a hardness of 40 and ELASTOSIL (LR3071) having a hardness of 50 may be used as the liquid silicon.

In the method, in the step (b), the mixed solution may be prepared by mixing the liquid silicon and the toluene at a weight ratio of any one selected from among 1:1, 1:2 and 1:3.

Here, the mixed solution prepared by mixing the liquid silicon and the toluene at a weight ratio of 1:1 may be applied on the paper using any one selected from among a painting method and a printing method, and the mixed solution prepared by mixing the liquid silicon and the toluene at a weight ratio of 1:2 and 1:3 may be applied on the paper using a spraying method.

In the method, the step (c) of forming the paper may include the steps of: applying the mixed solution on an area of the paper selected in order to form the paper vessel, except an adherend area thereof; and heating the paper coated with the mixed solution at a predetermined temperature for a predetermined time to remove the toluene and cure the silicon coating layer.

In order to accomplish the above objects, a yet another aspect of the present invention provides a method of manufacturing a silicon-coated paper vessel, including the steps of: (a) providing liquid silicon and toluene; (b) mixing the liquid silicon and the toluene at a predetermined weight ratio to prepare a mixed solution; (c) forming paper into a paper vessel; and (d) applying the mixed solution on the paper vessel and then heating and curing the paper vessel coated with the mixed solution.

### ADVANTAGEOUS EFFECTS

The paper vessel according to the present invention is advantageous in that it can improve the freshness and safety of food because it is coated with silicon.

Further, the paper vessel according to the present invention is advantageous in that it is not harmful to the human body because it is coated with silicon for the purpose of water-proofness and moisture proofness.

Furthermore, the method of manufacturing the paper vessel according to the present invention is advantageous in that the paper vessel can be easily manufactured by pressing the silicon-coated paper using a die assembly or by adhering the silicon-coated paper to non silicon-coated paper.

### BRIEF DESCRIPTION OF DRAWINGS

FIG. 1 is a flowchart showing a method of manufacturing a paper vessel coated with silicon according to a first embodiment of the present invention;

FIG. 2 is a view showing a method of manufacturing a silicon-coated paper by applying a mixed solution on paper and then heating and curing the mixed solution according to an embodiment of the present invention;

FIG. 3 is a view showing a process of forming the silicon-coated paper into a cup-shaped food vessel through an adhesive forming process according to an embodiment of the present invention;

FIG. 4 is a view showing a process of forming the silicon-coated paper into a paper vessel through a press forming process according to an embodiment of the present invention;

FIG. 5 is a view showing an entire process of manufacturing a paper vessel coated with silicon according to a first embodiment of the present invention;

FIG. 6 is a flowchart showing a method of manufacturing a paper vessel coated with silicon according to a second embodiment of the present invention;

FIG. 7 is a view showing an entire process of manufacturing a paper vessel coated with silicon according to a second embodiment of the present invention; and

FIG. 8 is a scan view showing the results of the extraction test of a silicon coating layer of a paper cup formed using silicon-coated paper according to an embodiment of the present invention.

### DESCRIPTION OF THE ELEMENTS IN THE DRAWINGS

100: paper
102, 106, 108: adhering area
104: adherend area
110: mixed solution
120: silicon coating layer
140: lower die
145: upper die.

### BEST MODE FOR CARRYING OUT THE INVENTION

In the description of embodiments of the present invention, technical contents, which are not directly related to the present invention and are well known to those skilled in the art, will be omitted for the more clear transmission of the gist of the present invention.

Hereinafter, preferred embodiments of the present invention will be described in detail with reference to the attached drawings.

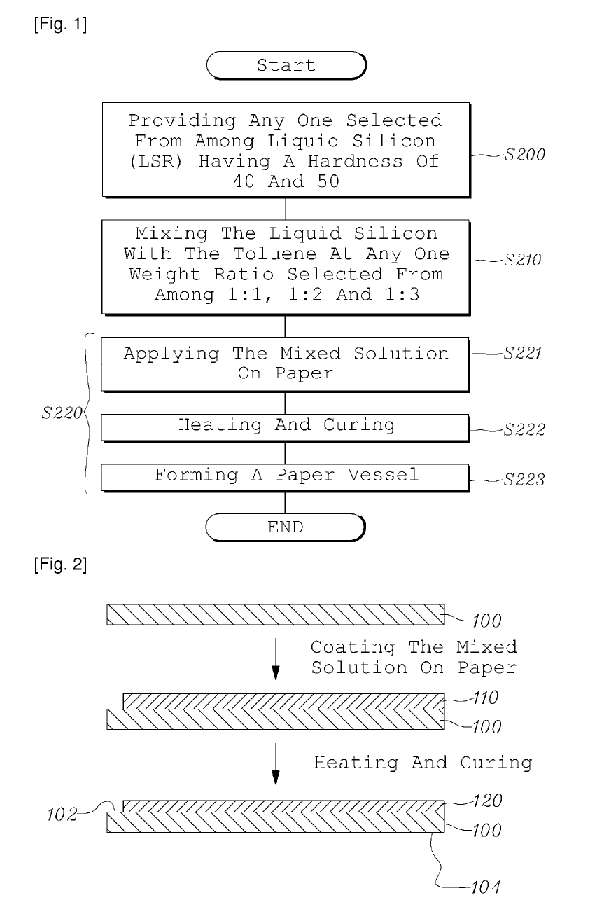

FIG. 1 is a flowchart showing a method of manufacturing a paper vessel coated with silicon according to a first embodiment of the present invention.

Referring to FIG. 1, a method of manufacturing a paper vessel coated with silicon according to a first embodiment of the present invention includes the steps of: providing any one selected from among liquid silicon (LSR) having a hardness of 40 and liquid silicon having a hardness of 50, which are manufactured by Wacker Chemie Corp. in Germany, and toluene (S200); mixing the liquid silicon with the toluene at any one weight ratio selected from among 1:1, 1:2 and 1:3 to form a mixed solution 110 (S210); and applying the mixed solution on paper and then heating and curing the paper coated with the mixed solution to form a paper vessel (S220).

It is preferred that ELASTOSIL (LR3071: Brand name), manufactured by Wacker Chemie Corp. in Germany, be used as the liquid silicon. In the present invention, any one selected from among ELASTOSIL (LR3071) having a hardness of 40 and ELASTOSIL (LR3071) having a hardness of 50 may be used as the liquid silicon.

When the liquid silicon has high hardness, a large amount of toluene is mixed with the liquid silicon in order to form the mixed solution. In contrast, when the liquid silicon has low hardness, a small amount of toluene may be mixed with the liquid silicon in order to form the mixed solution. Therefore, liquid silicon having optimal hardness must be selected in consideration of various aspects such as processing time, working space, costs, transportation, storage, control, and the like. The mixing ratios of toluene to liquid silicon depending on the difference in hardness of the liquid silicon are given in Table 1 below.

TABLE 1
Mixing ratios of toluene to liquid silicon depending
on the difference in hardness of the liquid silicon

| | | | | | | |
|---|---|---|---|---|---|---|
| Hardness | 20 | 30 | 40 | 50 | 60 | 70 |
| Mixing ratio of toluene | 0.7 | 0.8 | 0.9 | 1 | 1.1 | 1.2 |

Referring to Table 1, in the case where the weight ratio of toluene to be mixed to liquid silicon having a hardness of 50 is 1:1, liquid silicon having a hardness of 40 is mixed with toluene such that the weight ratio of the toluene to the liquid silicon is 0.9, and liquid silicon having a hardness of 60 is mixed with toluene such that the weight ratio of the toluene to the liquid silicon is 1.1. These results were obtained by repeated experiments and efforts for a long time. That is, the amount of toluene mixed with liquid silicon is changed as in Table 2 according to the difference in hardness of liquid silicon based on the liquid silicon having a hardness of 50. Further, when the weight ratio of toluene mixed with liquid silicon is changed into a double or triple ratio, the weight ratio given in Table 1 is also changed into a double or triple ratio.

Since liquid silicon (LSR), which is liquid silicon rubber, contains a rubber component, it has adhesiveness, but cannot exhibit adhesiveness when the concentration of rubber is excessively high. Therefore, in order for the liquid silicon (LSR) to exhibit adhesiveness, it must be properly diluted. Further, since silicon rubber has chemical stability and maintains elasticity even in a wide temperature range, it is usefully used in various fields.

Silicone (Si) is a general term of polymers of organic silicon compounds containing silicon having an atomic number of 14, and is also called polysiloxane. Since silicon fluid is not easily decomposed by water, heat or oxidants, it is known to be not harmful to the human body.

Silicon is used as an electrical insulating material because it has excellent insulation properties, is used as a material for destroying the fluid components and emulsion in hydraulic systems, and is used to impart waterproofness to fabrics or paper. Silicon rubber has excellent insulation properties and chemical stability and maintains elasticity even in a wide temperature range. Silicon resin is used to manufacture protective coating agents, varnish for electrical insulation, and thin glass fiber textiles.

That is, since silicon has excellent heat resistance, is not decomposed by oxidants and is very chemically stable, there is no danger of it being absorbed by the human body, and thus it is used as a material for the safest artificial implants of the body.

Toluene is a volatile material used as a raw material for synthesis or used as a solvent for dissolving organic matter.

Generally, toluene is called methylbenzene, has a chemical formula of C7H8, and is a colorless liquid emitting a peculiar smell. Since toluene has a molecular weight of 92.14, a boiling point of 110.8° C. and a specific gravity of 0.87 at 15° C., it vaporizes and thus completely disappears when it is heated. As the liquid silicon, an ELASTOSIL-based solution A and an ELASTOSIL-based solution B, which are manufactured by Wacker Chemie Corp. in Germany, are used. When the two solutions are mixed with each other at a mixing ratio of 1:1, the liquid silicon is cured.

Since liquid silicon (LSR) exhibits low adhesiveness when its concentration is high, toluene is mixed with the liquid silicon (LSR) to decrease its concentration, thereby increasing its adhesiveness. That is, since the liquid silicon has high viscosity, its concentration must be controlled low such that it is suitably applied using any one selected from among a painting process using brushes or rollers, a printing process and a spraying process. Toluene is used to control the concentration of the liquid silicon.

Liquid silicon and toluene may be provided and mixed at any one weight ratio selected from among 1:1, 1:2 and 1:3 to form a mixed solution 110. The mixing ratio may be properly changed according to various conditions such as production circumstances and the like.

When the mixed solution 110 has a mixing ratio of 1:1, since the density of the liquid silicon is high, the mixed solution is applied using any one selected from among a painting process using brushes or rollers and a printing process.

As described above, the weight ratios of toluene mixed with liquid silicon according to the difference in hardness of liquid silicon are given in Table 1. That is, when the weight ratio of toluene mixed with liquid silicon is 1:1 based on the liquid silicon having a hardness of 50, the mixing ratio of toluene to the liquid silicon according to the difference in hardness of liquid silicon is changed. Further, when the weight ratio of toluene mixed with liquid silicon is changed into a double or triple ratio for the above reason, the weight ratio given in Table 1 is also changed into a double or triple ratio.

Since silicon has rubber properties, an adhesive does not easily adhere to the silicon. Therefore, in the step (S231) of coating paper 100 with the mixed solution 110, the reason why the paper 100 is selectively coated is that an adhesive is applied onto an area on which the mixed solution 110 is not applied, and thus the area adheres to other areas. Here, when an adhering method or an adhesive forming method is not used, the selected area of the paper 100 becomes the entire surface of the paper 100.

For this reason, when the mixed solution 110 is applied on the paper 100, the mixed solution 110 is applied only on the selected area of the paper 100 or is not applied only to the selected area thereof. If necessary, the entire surface of the paper 100 is coated with the mixed solution 110. In this case, the area of the paper 100, on which a silicon coating layer 120 is not formed because the mixed solution 110 was not applied thereon, is bonded with other areas thereof using an adhesive.

In the present invention, when the mixed solution 110 is applied onto the paper 100 using a painting or printing method, it is preferred that liquid silicon and toluene be mixed at a weight ratio of 1:1, and when the mixed solution 110 is applied onto the paper 100 using a spraying method, it is preferred that liquid silicon and toluene be mixed at a weight ratio of 1:2 or 1:3.

That is, as the mixing ratio of toluene to liquid silicon is increased, the mixed solution 110 is more easily applied onto the paper 100 using a spraying method and is more easily infiltrated into the paper 100. The mixing ratio may be adjusted depending on the coating method and the technical reasons.

Next, the step (S220) of forming a paper vessel will be described in detail. First, the mixed solution 110 is applied onto the area of the paper 100 selected in order to form the paper vessel, except the adherend area thereof, using any one selected from among a painting method, a printing method and a spraying method (S221). The adherend area thereof is not coated in order to easily adhere an adhesive thereto when the paper vessel is formed using an adhering method.

Subsequently, the paper 100 coated with the mixed solution 110 is heated at a predetermined temperature range for a predetermined time to completely vaporize and remove toluene, and then a silicon coating layer is cured and is thus fixed on the paper 100 (S222).

The non-coated area 102 of the paper on which the silicon coating layer 120 is cured is coated with an adhesive, and then the paper 100 coated with the mixed solution 110 is formed into a paper vessel using an adhesive forming method or a press forming method (S223).

Here, the heating of the paper 100 coated with the mixed solution 110 is conducted at a temperature ranging from 100 to 250° C. In this case, the heating of the paper 100 coated with the mixed solution 110 is conducted for 1 hour at 100° C. or for 30 seconds˜1 minute at 250° C. under the condition that the paper 100 is coated with a mixed solution 110 in which liquid silicon (LSR) and toluene are mixed at a weight ratio of 1:1.

Toluene is added in order to decrease the density of liquid silicon (LSR) and simultaneously increase the adhesiveness thereof. When the liquid silicon (LSR) is mixed with the toluene and thus diluted, the adhesiveness thereof, and thus the liquid silicon (LSR) diluted with the toluene is easily applied on the surface of other subjects or on the surface of the paper 100.

Among coating methods, in a painting method and a printing method, the mixed solution is relatively slowly applied onto the paper, whereas the thickness of the silicon coating layer is increased. In contrast, in a spraying method, the mixed solution is relatively rapidly applied onto the paper, whereas the thickness of the silicon coating layer is decreased.

Specifically, in the step (S222) of curing, the paper 100 selectively coated with the mixed solution 110 is heated at a predetermined temperature for a predetermined time to completely vaporize toluene.

Although toluene is a poisonous colorless liquid, it is volatile, is used as a solvent, and is easily vaporized by heating to be completely removed. In the step of heating and curing, liquid silicon is applied on the paper to form a thin silicon coating layer 120.

The paper 100 coated with the mixed solution 110 is heated at a temperature ranging from 100 to 250° C. for 30 minutes˜1 hour to completely vaporize toluene.

The heating conditions of the paper 100 coated with the mixed solution 110 are changed according to the mixing ratio of toluene to liquid silicon. For example, it was experimentally verified that, in the case where liquid silicon (LSR) and toluene are mixed at a weight ratio of 1:1, when the paper 100 coated with the mixed solution 110 is heated for 30 seconds˜1 minute at 250° C. or for 1 hour at 100° C., toluene is completely vaporized.

Korea Environment & Merchandise Testing Institute (KEMTI), which is an institution for testing, inspection and correction authorized by the Korean Government, tested a cup which is made of paper coated with a mixed solution of liquid silicon and toluene and from which toluene is removed by heating based on “Standards and Specifications of appliance and container package” of section 7 of Food Code of Korea Food & Drug Administration (KFDA). As a result, the cup satisfied and passed the Standards and Specifications thereof, and the results thereof are shown in FIG. 8.

FIG. 8 is a test report showing the results of the extraction test of a silicon coating layer of a cup made of silicon-coated paper according to an embodiment of the present invention. From FIG. 8, it can be seen that the amount of lead (Pb) (which is a heavy metal extracted from a silicon coating layer 120 (silicon resin) of a cup made of the paper coated with the mixed solution 110 according to an embodiment of the present invention) satisfies the standards requirement of 1.0 mg/L or less, that the amount of potassium permanganate (KMnO₄) is 1 mg/L, which satisfies the standards requirement of 10 mg/L or less, and that the amount of residues formed by the vaporization of 4% acetic acid is 14 mg/L, which satisfies the standards requirement of 30 mg/L or less.

Therefore, it is verified by the test results of Korea Environment & Merchandise Testing Institute that, since the paper coated with the mixed solution according to the present invention is heated at a predetermined temperature for a predetermined time, toluene harmful to the human body is completely vaporized, and thus the toluene is not detected.

The heating conditions of the paper coated with the mixed solution are given in Table 2 below.

TABLE 2
The heating conditions of the paper coated with the mixed solution

| | Heating temperature | | |
|---|---|---|---|
| | Room temperature | 100° C. | 250° C. |
| Evaporation time of | 25 hours or more | about | about 30 seconds ~1 |
| toluene | | 1 hour | minute |

Referring to Table 2, the evaporation time of toluene is increased as the mixing ratio of toluene is increased. For example, when liquid silicon and toluene are mixed at a weight ratio of 1:2, the evaporation time of toluene is increased to the double time, and when liquid silicon and toluene are mixed at a weight ratio of 1:3, the evaporation time of toluene is increased to the triple time. However, the optimal evaporation time of toluene can be selected by controlling the heating temperature.

When the paper 100 coated with the mixed solution 110 is heated at the predetermined temperature for the predetermined time as above, toluene included in the mixed solution 110 is completely vaporized, and simultaneously the silicon coating layer 120 is cured and thus thinly adheres to the paper 100.

Hereinafter, a method of manufacturing a silicon-coated paper by applying a mixed solution on paper and then heating and curing the mixed solution according to an embodiment of the present invention will be described in detail with reference to FIG. 2.

FIG. 2 is a view showing a method of manufacturing a silicon-coated paper by applying a mixed solution on paper and then heating and curing the mixed solution according to an embodiment of the present invention. As shown in FIG. 2, paper 100 is provided, and then a mixed solution 110 in which liquid silicon (LSR) and toluene are mixed at a predetermined mixing ratio is selectively applied on the provided paper 100 using any one selected from among a painting method, a printing method and a spraying method.

The mixed solution 110 may be entirely or partially applied on the paper 100.

In this case, an adhering area 102 of the paper 100 must not be coated with the mixed solution 110 but an adhesive is instead applied on the adhering area 102. The adhering area 102 of the paper 100 is bonded with an adherend area 104 thereof located at one end of the paper 100, and thus the paper 100 is formed into a cylindrical shape. Further, a bottom cover is bonded with the adhering area 102 of the paper 100 located at the other end of the paper 100, and thus the paper 100 is formed into a vessel shape. Such a method is referred to as an adhesive forming method.

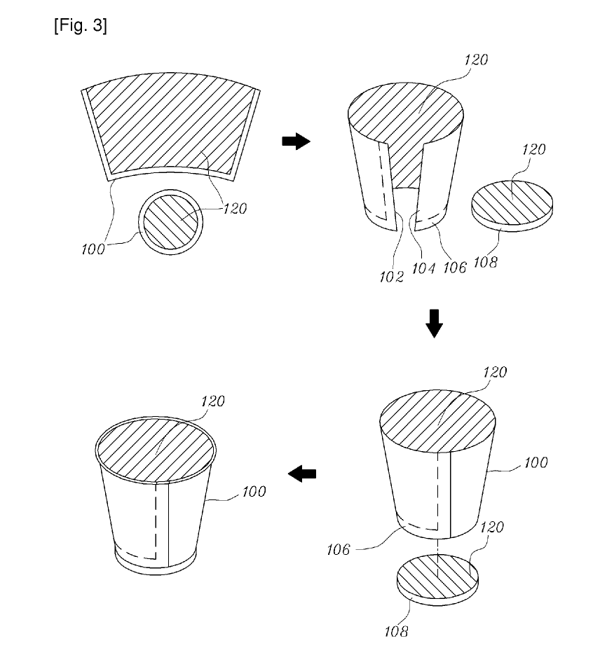

Hereinafter, a process of forming the silicon-coated paper into a cup-shaped food vessel through an adhesive forming process according to an embodiment of the present invention will be described in detail with reference to FIG. 3.

FIG. 3 is a view showing a process of forming the silicon-coated paper into a cup-shaped food vessel through an adhesive forming process according to an embodiment of the present invention. Referring to FIG. 3, a mixed solution 110 is applied on only the selected areas of fan-shaped or arc-shaped paper and circular paper, except for on the adhering areas thereof 102, 106 and 108, and then the paper 100 coated with the mixed solution 110 is heated and cured at a predetermined temperature for a predetermined time to form a silicon coating layer 120. The coating layer 120 is fixed on the paper.

In this case, the adhering area 102 of the arc-shaped paper 100 is bonded with the adherend area 104 thereof using an adhesive, and thus the arc-shaped paper 100 is formed into a cylindrical shape. Further, the adhering area 106 thereof located at the upper end thereof is also bonded with the adhering area 108 of the circular paper 100 using an adhesive, thereby forming a vessel for food.

When the vessel is formed using an adhesive forming method, since an adhesive cannot be fixed due to the rubber properties of silicon, it is very important not to coat the adhering areas of the paper with silicon.

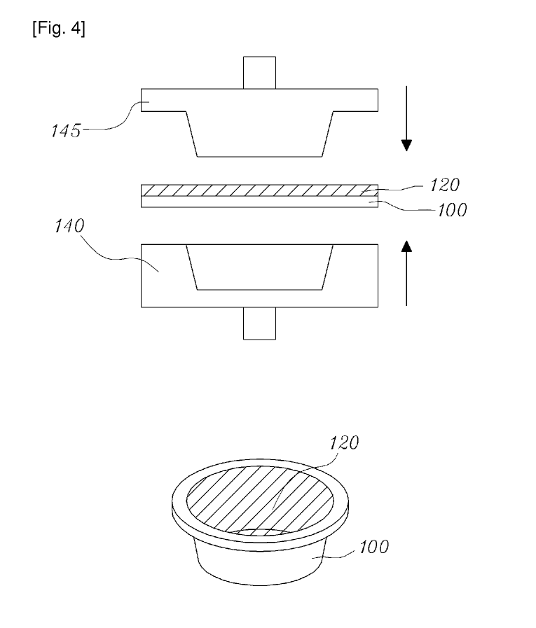

Hereinafter, a process of forming the silicon-coated paper into a paper vessel through a press forming process according to an embodiment of the present invention will be described in detail with reference to FIG. 4.

As shown in FIG. 4, paper 100 on which a silicon coating layer 120 is formed is introduced into a die assembly including an upper die 145 and a lower die 140, and the upper and lower dies 140 and 145 are coupled with each other.

Then, the coupled upper and lower dies 140 and 145 are decoupled from each other, and then the paper 100 on which the silicon coating layer 120 was applied is separated from the die assembly, thereby forming a paper vessel.

In this press forming method, a mixed solution is provided, and then the mixed solution is applied on paper, and then the paper coated with the mixed solution is heated and cured to form a paper vessel. Therefore, this press forming method is advantageous in that the process is relatively simple, and thus the entire production process can be easily controlled.

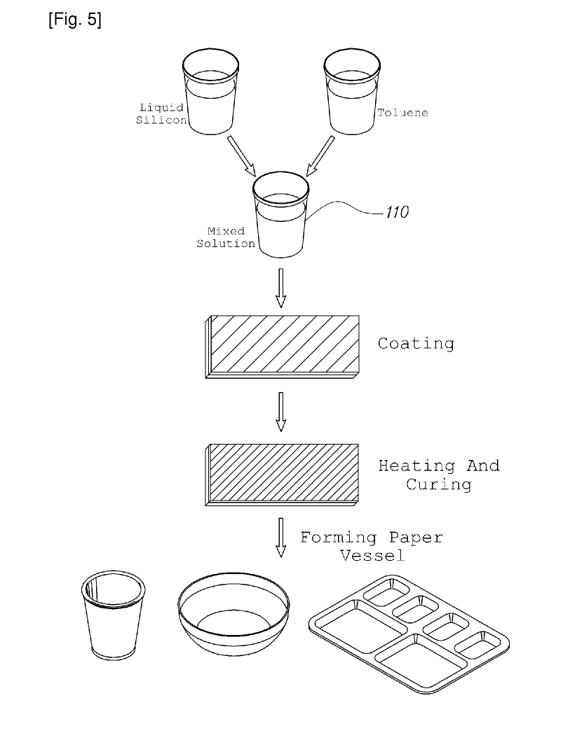

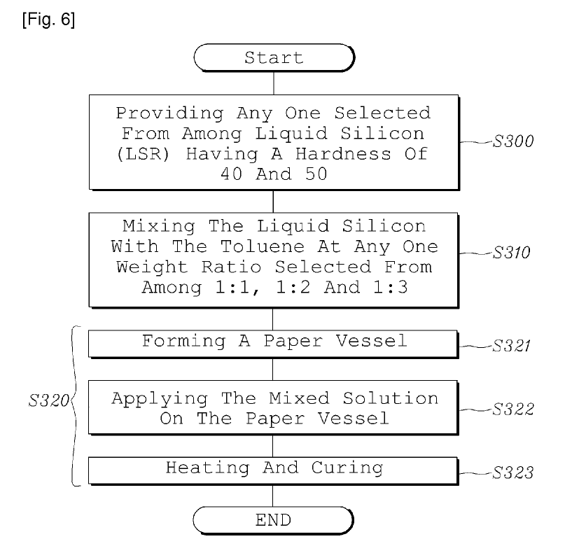

Hereinafter, the entire process of manufacturing a paper vessel coated with silicon according to a first embodiment of the present invention will be described in detail with reference to FIG. 5.

FIG. 5 is a view showing an entire process of manufacturing a paper vessel coated with silicon according to a first embodiment of the present invention. As shown in FIG. 5, liquid silicon (LSR) and toluene are provided, and then they are mixed at a predetermined mixing ratio to form a mixed solution 110. Then, the mixed solution is applied on the selected area of paper and then heated and cured to form a silicon coating layer 120 on the paper. Subsequently, the paper on which the silicon coating layer 120 was applied is formed into a paper vessel using a press forming method or an adhesive forming method. These procedures are sequentially shown in FIG. 5.

FIG. 6 is a flowchart showing a method of manufacturing a paper vessel coated with silicon according to a second embodiment of the present invention.

Referring to FIG. 6, a method of manufacturing a paper vessel coated with silicon according to a second embodiment of the present invention includes the steps of: providing any one selected from among liquid silicon (LSR) having a hardness of 40 and liquid silicon having a hardness of 50, which are manufactured by Wacker Chemie Corp. in Germany, and toluene (S300); mixing the liquid silicon with the toluene at any one weight ratio selected from among 1:1, 1:2 and 1:3 to prepare a mixed solution 110 (S310); and forming paper into a paper vessel, applying the mixed solution on the paper vessel and then heating and curing the paper vessel coated with the mixed solution (S320).

The redundant description of the step (S300) of providing the liquid silicon and the toluene and the step (S310) of preparing the mixed solution will be omitted because the description thereof is substantially identical to the first embodiment of the present invention.

The step (S320) of heating and curing the paper vessel will be described in detail. First, a paper is formed into a paper vessel using any one selected from among a press forming method and an adhesive forming method (S321). Then, a mixed solution 110 is applied on an area of the paper vessel, with which food is directly brought into contact (S322). The application of the mixed solution may be conducted using a mixed solution in which liquid silicon and toluene are mixed at a weight ratio of 1:1 through a painting or printing method, but it is preferred that the application of the mixed solution be conducted using a mixed solution in which liquid silicon and toluene are mixed at a weight ratio of 1:2 or 1:3 through a spraying method because the paper vessel has a three-dimensional shape. In particular, when the toluene content of a mixed solution, such as a mixed solution in which liquid silicon and toluene are mixed at a weight ratio of 1:3, is increased, since the permeability thereof is also increased, the mixed solution having high toluene content can be deeply applied on the three-dimensional paper vessel. The mixing ratio of liquid silicon and toluene by weight can be adjusted according to various conditions, such as the working environment, production facilities, and the like.

Subsequently, since the paper vessel coated with the mixed solution is heated at a predetermined temperature for a predetermined time, toluene is completely removed, and the mixed solution is cured (S323).

The redundant description of the predetermined temperature and the predetermined time will be omitted because the description thereof is substantially identical to the first embodiment of the present invention.

In the second embodiment of the present invention, after a process of forming a paper vessel, all of the application, heating and curing processes are sequentially conducted. Therefore, there is an advantage in that the adhering part of the paper vessel is strengthened.

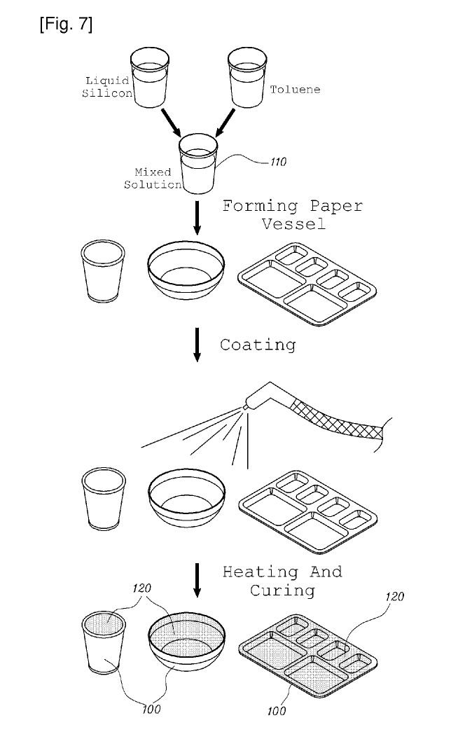

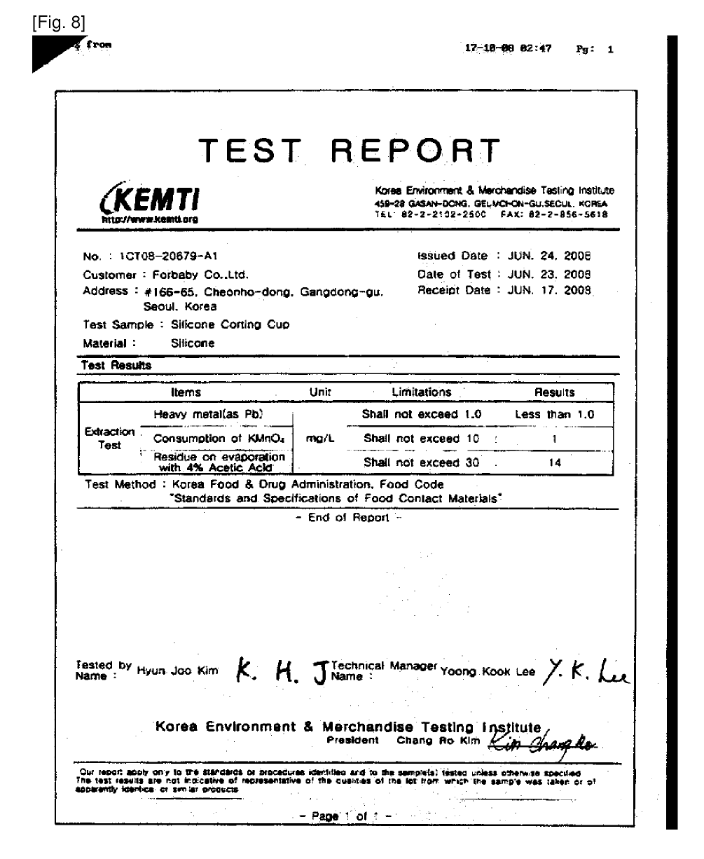

Hereinafter, an entire process of manufacturing a paper vessel coated with silicon according to the second embodiment of the present invention will be described in detail with reference to FIG. 7.

FIG. 7 is a view showing an entire process of manufacturing a paper vessel coated with silicon according to the second embodiment of the present invention. As shown in FIG. 7, liquid silicon (LSR) and toluene are provided, and then they are mixed at a weight ratio of 1:1, 1:2 or 1:3 to form a mixed solution 110. Then, paper is shaped into a paper vessel using a press forming method or an adhesive forming method.

Subsequently, the mixed solution 110 is applied on an area of the paper vessel, with which food is directly brought into contact, using any one selected from among a painting, printing method and a spraying method. In this case, it is preferred that the paper vessel be applied through a spraying method because the paper vessel has a three-dimensional shape. Further, it is preferred that a mixed solution in which liquid silicon and toluene are mixed at a weight ratio of 1:3 be used in order to coat the paper vessel in every nook and corner.

Since the paper vessel coated with the mixed solution 110 is heated at a predetermined temperature for a predetermined time, toluene is completely removed, and the silicon coating layer 120 is cured, thus fixedly coating the paper vessel. These procedures are sequentially shown in FIG. 7.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A silicon-coated paper, manufactured by applying a mixed solution on a selected area of paper in which the mixed solution is composed of liquid silicon and toluene mixed at a predetermined mixing ratio, and then heating the paper coated with the mixed solution at a predetermined temperature for a predetermined time to completely remove the toluene and simultaneously cure the liquid silicon.

2. The silicon-coated paper according to claim 1, wherein the mixed solution is prepared by mixing the liquid silicon and the toluene at a weight ratio of 1:1˜1:3.

3. The silicon-coated paper according to claim 1, wherein the predetermined temperature is in a range of 100 to 250° C., and the predetermined time is 1 hour at 100° C. and 30 seconds ˜1 minute at 250° C. under a condition that the paper is coated with the mixed solution in which liquid silicon and toluene are mixed at a weight ratio of 1:1.

4. A silicon-coated paper vessel, manufactured by forming the silicon-coated paper of claim 1.

5. A silicon-coated paper vessel on which a silicon coating layer is provided, manufactured by forming paper into a paper vessel, applying a mixed solution on the paper vessel in which the mixed solution is composed of liquid silicon and toluene mixed at a predetermined mixing ratio, and then heating the paper vessel coated with the mixed solution at a predetermined temperature for a predetermined time to completely remove the toluene and simultaneously cure the liquid silicon.

6. The silicon-coated paper vessel according to claim 5, wherein the mixed solution is prepared by mixing the liquid silicon and the toluene at a weight ratio of 1:1˜1:3.

7. The silicon-coated paper vessel according to claim 5, wherein the predetermined temperature is in a range of 100 to 250° C., and the predetermined time is 1 hour at 100° C. and 30 seconds ˜1 minute at 250° C. under a condition that the paper vessel is coated with the mixed solution in which liquid silicon and toluene are mixed at a weight ratio of 1:1.

8. A method of manufacturing a silicon-coated paper vessel, comprising the steps of:
(a) providing liquid silicon and toluene;
(b) mixing the liquid silicon and the toluene at a predetermined weight ratio to prepare a mixed solution;
(c) applying the mixed solution on paper and then heating and curing the applied mixed solution to form paper coated with the mixed solution; and
(d) forming the paper coated with the mixed solution into a paper vessel.

9. The method according to claim 8, wherein the liquid silicon has a hardness of 40˜50.

10. The method according to claim 8, wherein, in the step (b), the mixed solution is prepared by mixing the liquid silicon and the toluene at a weight ratio of 1:1˜1:3.

11. The method according to claim 10, wherein the mixed solution prepared by mixing the liquid silicon and the toluene at a weight ratio of 1:1 is applied on the paper using any one selected from among a painting method and a printing method, and the mixed solution prepared by mixing the liquid silicon and the toluene at a weight ratio of other than 1:1 is applied on the paper using a spraying method.

12. The method according to claim 8, wherein the step (c) comprises the steps of:
applying the mixed solution on an area of the paper selected in order to form the paper vessel, except for on an adherend area thereof; and
heating the paper coated with the mixed solution at a predetermined temperature for a predetermined time to remove the toluene and cure the silicon coating layer.

13. The method according to claim 12, wherein the predetermined temperature is in a range of 100 to 250° C., and the predetermined time is 1 hour at 100° C. and 30 seconds ˜1 minute at 250° C. under a condition that the paper is coated with the mixed solution in which liquid silicon and toluene are mixed at a weight ratio of 1:1.

14. The method according to claim 8, wherein, in the step (d), the paper on which the cured silicon coating layer was applied is formed into the paper vessel using any one selected from among an adhesive forming method and a press forming method.

15. A method of manufacturing a silicon-coated paper vessel, comprising the steps of:
(a) providing liquid silicon and toluene;
(b) mixing the liquid silicon and the toluene at a predetermined weight ratio to prepare a mixed solution;
(c) forming paper into a paper vessel; and
(d) applying the mixed solution on the paper vessel and then heating and curing the paper vessel coated with the mixed solution.

16. The method according to claim 15,
wherein the step (d) comprises the steps of:
coating the paper vessel with the mixed solution; and
heating the paper vessel coated with the mixed solution at a predetermined temperature for a predetermined time to remove the toluene and cure the silicon coating layer.

17. The method according to claim 16, wherein the predetermined temperature is in a range of 100 to 250° C., and the predetermined time is 1 hour at 100° C. and 30 seconds ˜1 minute at 250° C. under a condition that the paper vessel is coated with the mixed solution in which liquid silicon and toluene are mixed at a weight ratio of 1:1.

18. A silicon-coated paper vessel, manufactured by forming the silicon-coated paper of claim 2.

19. A silicon-coated paper vessel, manufactured by forming the silicon-coated paper of claim 3.
